(19) United States
(12) Patent Application Publication
(10) Pub. No.: US 2003/0040286 A1
(43) Pub. Date: Feb. 27, 2003

(54) Signaling cellular phone carrier

(76) Inventor: Terry Walter, Cincinnati, OH (US)

Correspondence Address: DANIEL B. RUNK, 1400 PROVIDENT TOWER, ONE EAST FOURTH STREET, CINCINNATI, OH, 45202, US

(21) Appl. No.: 09/934,112

(22) Filed: Aug. 21, 2001

(51) Int. Cl. H04B 1/38

(52) U.S. Cl. 455/90; 455/567

(57) ABSTRACT

A signaling carrying device for carrying a cellular phone comprised of a volume with one or more compartments capable of holding a cellular telephone and the carrying device having a receiver therein that receives a signal when a telephone call is received by the cellular telephone and causes at least one lighting device located on the carrying device to illuminate upon receiving an incoming call.

### FIELD OF INVENTION

This invention relates generally to the field of carrying devices, and more particularly to a carrier for carrying cellular telephones that signals the person carrying the device with a light when an incoming phone call is received.

### BACKGROUND OF THE INVENTION

In the past, a person has typically carried his or her cellular telephone either by itself without any casing, in a small phone-sized case or in a larger carrying case or bag, such as a purse, with many other items. In using either traditional carrying case, the user is required to rely on the standard notification mechanisms of the telephone, such as ringing or vibration to notify the user of an incoming call. Use of the standard notification mechanisms can be intrusive or inconvenient. Also, use of these carrying devices does not result in the most convenient manner of carrying the cellular phone since carrying the phone itself or in a smaller phone-sized case results in the person having to carry an additional item while a traditional larger carrying case or bag is problematic since they result in the cellular phone being stored out of sight and more difficult to access.

Alternative call notification devices have been developed, but not used in traditional carrying devices. Typically, the user simply puts the cellular phone in a small or large carrying case and relies upon the notification device built into the cellular phone. LED's have been used on telephones and other accessories, such as clips and pens, to provide non-intrusive notification of incoming telephone calls to the user; however, such devices have not been used on carrying devices.

A number of different types of small carrying cases have been designed by manufacturers of cellular phones and after-market accessories. Typically they consist of a small case that holds the phone itself along with a few small phone accessories and the cases are customized for a particular model of cellular phone. A typical small carrying case is shown and described by Tetrault in U.S. Design Pat. No. D369,903.

A number of different types of larger carrying cases exist, but typically they are designed with other uses in mind, such as standard purses, duffel bags, suitcases, etc. Other larger carrying cases have been designed specifically for the cellular phone. One such device is designed to secret the telephone away in a pivoting compartment, such as that described by Su in U.S. Pat. No. 6,123,127. Other typical “pouch” sized carrying devices are described by Daniels in U.S. Design Pat. No. D343,059 and Cincotta in U.S. Design Pat. No. D368,581. Another such device has an internal pocket for a telephone, such as that described by Abelbeck in U.S. Pat. No. 5,961,018.

As mentioned, none of the existing carrying devices incorporate their own notification mechanisms to notify cellular phone users that an incoming call is being received, and phone users can only detect incoming calls within traditional carrying devices when the phone rings or vibrates inside of the carrier. Further, while a number of carrying devices exist, designed both for general carrying of items and specifically for cellular phones, and such carrying devices are well developed, the existing technologies do not provide a convenient carrying device that permits the storage of other articles along with the cellular phone along with an easily viewable call notification device. As a result, significant improvement can still be made in the area of phone carrying devices.

It is the primary object of the present invention to notify the user of a carrying device of incoming calls without relying on the usual disruptive notification mechanisms built into cellular phones, such as ringing or vibration mechanisms. Another object of the invention is to permit users to be notified of incoming phone calls via the notification mechanism when the user is in noisy environments in which the standard notification devices, such as ringing or vibrations, may not be capable of alerting the user to the incoming call. Another object of the invention is to enable people to carry their cellular telephones in a carrying device along with other articles.

### SUMMARY OF THE INVENTION

The present invention is a carrying device that includes a standard carrying case, such as a purse, with at least one compartment in which a cellular telephone can be situated. The carrying case can be made out of any available material, but is typically made with common materials such as such as leather, fabric, plastic or vinyl. The carrying device incorporates LEDs that illuminate when an incoming telephone call is received, thereby silently notifying the user of the incoming call. The LEDs illuminate up when a receiver in the carrying device, typically sewn into the lining, is activated by a signal transmitted from the cellular phone after the cellular phone receives the incoming telephone call. As a result of the invention, people may conveniently carry their cellular phones and be notified of incoming calls in a non-disruptive manner. The carrying device may also incorporate a transparent panel in the phone compartment thereby permitting the user to view the phone display without needing to access the interior of the carrying device or the phone compartment. The phone compartment may also incorporate a hole or gap in the carrying device over one or both sides of the top of the phone compartment, thereby allowing the phone antenna to extend through the hole or gap, if necessary, and thereby improve the positioning of the phone within the phone compartment and carrying device. The phone can be aligned with the transparent portion of the compartment by using a simple booster device, such as a small box, to align a particular phone model display with the transparent panel.

The size, shape and other specifications of the carrying devices, LEDs, compartments and booster devices can be varied and they can be positioned in a variety of arrangements. In the preferred embodiment, the carrying device is a purse with multiple compartments, including at least one phone compartment in which the cellular phone may be stored and viewed through the back side of the purse that faces away from a closing flap, thereby permitting the transparent section over the display to be substantially flat. The top side of the phone compartment also has two holes or notches to allow the cellular phone antenna to extend beyond the top of the phone compartment, if necessary; the two holes allow cellular phones designs with the antenna to the right or left of the display to be easily stored in the phone compartment. The top side of the phone compartment also has two LEDs that are mounted on the top of the purse to make then easily seen by the user. The receiver circuit board and other electronics are sewn into the lining of the purse and the receiver circuit board activates the LEDs and causes them to flash in an alternating manner when an incoming telephone call is received by the user's phone. In the present invention, a 3 volt LED and receiver circuit board are powered by two 1.55 volt, 39 mAh silver oxide button cell batteries (model 1.736) which are held in place by a pair of battery mounting brackets. An antenna is attached to the receiving circuit and the voltage of the circuit is regulated by a standard 3 volt zener diode.

### BRIEF DESCRIPTION OF THE DRAWINGS

FIG. 1 is a front perspective view of an embodiment of the present invention.

FIG. 2 is a rear perspective view of an embodiment of the present invention.

FIG. 3 is a front perspective view of an embodiment of the present invention illustrating the invention in its opened condition.

FIG. 4 is a front perspective view illustrating the interior of an embodiment of the present invention in its opened condition.

### DETAILED DESCRIPTION

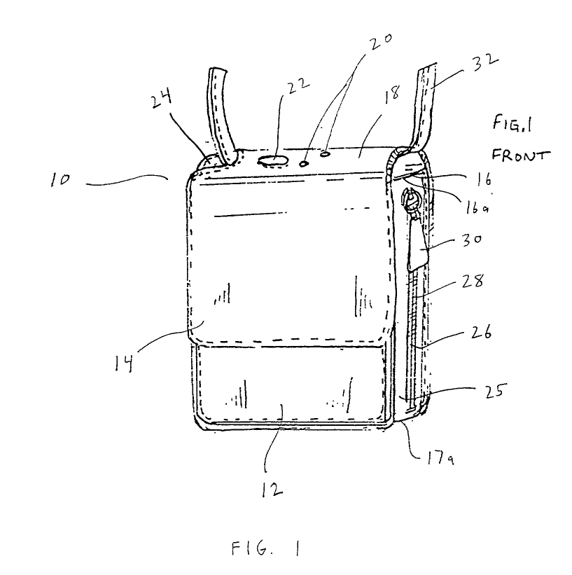

As illustrated in the perspective of FIG. 1, a carrying device indicated generally by the character numeral 10 is shown having a generally vertical configuration although other and different exterior configurations may be used as desired. Carrying device 10 has a front surface 12 which is overlapped by a flap 14 which is created by extending the back surface of the carrying device 10 over the top edge 16. The flap 14 has a flap top 18 portion that covers the open area formed by the top edge 16 and the flap top 18 has a pair of LEDs 20 used to notify the carrier of incoming telephone calls. The flap top 18 also has an antenna hole 22 and an antenna notch 24 to permit the cellular phone antenna to extend out of the carrying device 10 above the flap top 18. Access to a portion of the interior of the carrying device 10 is provided by access slot 26 in the right surface 25 running from the right top edge 16a to the right bottom edge 17a of the carrying device 10 which is opened and closed by using a zipper 28 and zipper pull 30 in a manner well known in the prior art.

The carrying device 10 preferably is provided with a carrying strap 32 that passes under the flap top 18 to enable the carrier to conveniently carry the carrying device 10. However, it should be understood that other carrying mechanisms may be employed as well such as, for example, a handle, a belt loop or backpack-style straps or simply carrying the carrying device 10 by hand without any carrying mechanism.

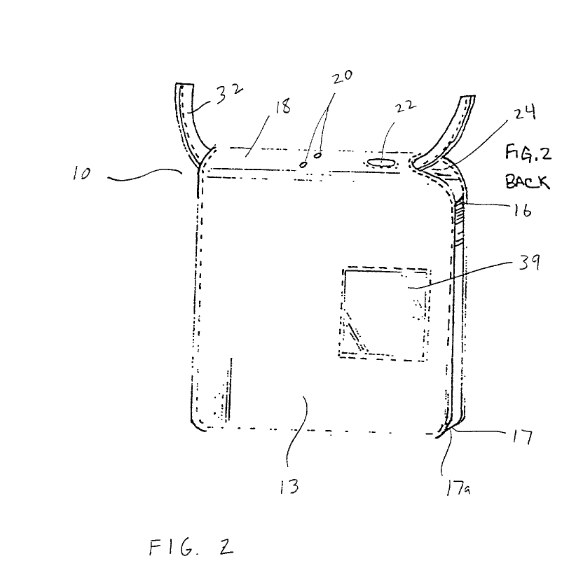

As illustrated in the perspective of FIG. 2, a carrying device 10 is shown having a generally vertical configuration although other and different exterior configurations may be used as desired. Carrying device 10 has a back surface 13 which has a transparent panel 39 that is stitched into a portion of the back surface 13. The carrying device 10 has a flap top 18 that covers the open area formed by the top edge 16 and the flap top 18 has a pair of LEDs 20 used to notify the carrier of incoming telephone calls. The flap top 18 also has an antenna hole 22 and an antenna notch 24 to permit the cellular phone antenna to extend out of the carrying device 10 above the flap top 18.

The carrying device 10 preferably is provided with a carrying strap 32 that passes under the flap top 18 to enable the carrier to conveniently carry the carrying device 10. However, it should be understood that other carrying mechanisms may be employed as well such as, for example, a handle, a belt loop or backpack-style straps or simply carrying the carrying device 10 by hand without any carrying mechanism.

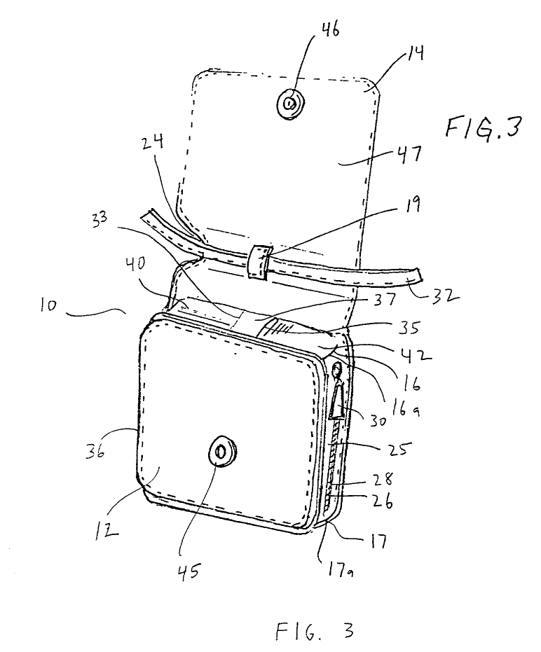

As illustrated in the perspective of FIG. 3, a carrying device 10 is shown having a generally vertical configuration although other and different exterior configurations may be used as desired. Carrying device 10 has a front surface 12 and a flap 14 that extends from the back surface of the carrying device 10. The carrying device 10 has right inner wall 35 and left inner wall 33 that each span between the front surface 12 and back surface to form a phone compartment 40 between the left inner wall 33 and the left surface 36, a center compartment 37 between the left inner wall 33 and right inner wall 35, and a zipper box compartment 42 between the right inner wall 35 and right surface 25. A transparent panel is located on the back side of the carrying device 10 corresponding to the phone compartment 40. A cellular phone may be placed in the phone compartment 40 in such a manner that the phone display is viewable through the transparent panel. A booster device may also be placed in the phone compartment 40 if necessary to raise the phone and enable viewing through the transparent panel. The front surface 12 has a female latching mechanism 45 that can be joined with the male latching mechanism 46 located on the inner flap surface 47 to close the flap 14 over the front surface 12. The flap 14 also has an antenna notch 24 and an antenna hole to permit the cellular phone antenna to extend out of the phone compartment 40 and above the flap 14. Access to a portion of the interior of the carrying device 10 is provided by access slot 26 in the right surface 25 running from the right top edge 16a to the right bottom edge 17a of the carrying device 10 which is opened and closed by using a zipper 28 and zipper pull 30 in a manner well known in the prior art.

The carrying device 10 preferably is provided with a carrying strap 32 that passes under the underside of the flap 14 and through a strap retainer 19 to enable the carrier to conveniently carry the carrying device 10. However, it should be understood that other carrying mechanisms may be employed as well such as, for example, a handle, a belt loop or backpack-style straps or simply carrying the carrying device 10 by hand without any carrying mechanism.

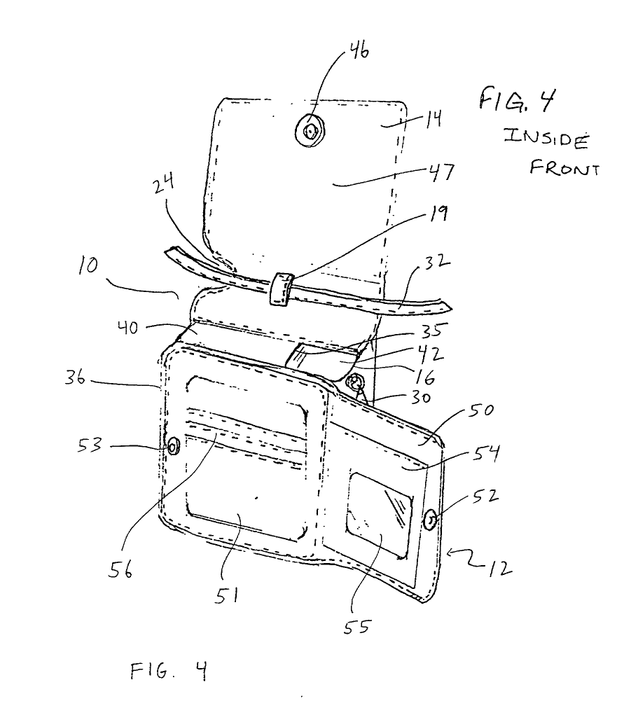

As illustrated in the perspective of FIG. 4, a carrying device 10 is shown having a generally vertical configuration although other and different exterior configurations may be used as desired. Carrying device 10 has a front surface 12 and a flap 14 that extends from the back surface of the carrying device 10. The flap 14 also has an antenna notch 24 and an antenna hole to permit the cellular phone antenna to extend out of the phone compartment 40 and above the flap 14. The carrying device 10 has an inner wall 35 that spans between the front and back surfaces to form a phone compartment 40 between the inner wall 35 and the left surface 36 and a zipper box compartment 42 between the inner wall 35 and right surface 25. A transparent panel is located on the back side of the carrying device 10 corresponding to the phone compartment 40. A cellular phone may be placed in the phone compartment 40 in such a manner that the phone display is viewable through the transparent panel. A booster device may also be placed in the phone compartment 40 if necessary to raise the phone and enable viewing through the transparent panel.

The carrying device 10 has a pivotable folio facing that when opened away from the main body of the carrying device 10 reveals an inner folio facing 51. The pivotable folio facing 50 has an inner folio male latching mechanism 52 that can be joined with the inner folio female latching mechanism 53 located on the inner folio facing 51 to close the pivotable folio facing 50 and provide a relatively smooth front surface 12 for the carrying device 10. The pivotable folio facing 50 also has an outer storage flap 54 with a transparent panel 55 that permits items inserted in the outer storage flap 54 to be viewed by the carrier through the transparent panel 55. The inner folio facing 51 has a number of inner storage flaps 56 in which items such as cash, credit cards or business cards may be placed.

When the pivotable folio facing 50 is closed against the inner folio facing 51 by joining the inner folio male latching mechanism 52 and inner folio female latching mechanism 53, the flap 14 may be closed against the front surface 12 by joining the female latching mechanism located on the front surface 12 with the male latching mechanism 46 located on the inner flap surface 47.

The carrying device 10 preferably is provided with a carrying strap 32 that passes under the underside of the flap 14 and through a strap retainer 19 to enable the carrier to conveniently carry the carrying device 10. However, it should be understood that other carrying mechanisms may be employed as well such as, for example, a handle, a belt loop or backpack-style straps or simply carrying the carrying device 10 by hand without any carrying mechanism.

The preceding description of the invention has shown and described certain embodiments thereof; however, it is intended by way of illustration and example only and not by way of limitation. Those skilled in the art should understand that various changes, omissions and additions may be made to the invention without departing from the spirit and scope of the invention.

I claim:

1. A carrying device for a cellular telephone comprising:
a) a volume capable of holding a cellular telephone; and
b) one or more lighting devices on said carrying device connected to at least one receiver wherein said receiver receives a signal when said cellular telephone receives a call and said receiver causes said lighting devices to illuminate upon receiving said signal.

2. That carrying device described in claim 1, wherein said lighting devices are light emitting diodes.

3. That carrying device described in claim 2, wherein said volume is formed by a body having front, back, side, top and bottom walls.

4. That carrying device described in claim 3, wherein said carrying device has two light emitting diodes located on the top wall of said carrying device.

5. That carrying device described in claim 1 wherein said carrying device has one or more compartments inside of said volume wherein at least one compartment is capable of holding a cellular telephone.

6. That carrying device described in claim 5, wherein said volume has at least one internal wall defining at least one compartment capable of holding a cellular telephone and at least one other compartment capable of holding other articles.

7. That carrying device described in claim 5, wherein said volume has one internal wall defining two compartments wherein one compartment is capable of holding a cellular telephone and the other compartment is capable of holding other articles.

8. That carrying device described in claim 5 wherein said carrying device has a transparent panel on at least one of said compartments capable of holding a cellular phone enabling a cellular phone to be viewable through said transparent panel.

9. That carrying device described in claim 8, wherein said compartment capable of holding a cellular phone has a booster cube having front, back, side, top and bottom walls placed at the bottom of said compartment resulting in the display portion said cellular telephone being viewable through said transparent panel.

10. That carrying device described in claim 5, wherein said compartment capable of holding a cellular telephone has two holes for the antenna of said cellular telephone to extend outside of the walls of said carrying device.

11. That carrying device described in claim 1, wherein said carrying device has a strap for carrying said carrying device.

12. A carrying device for a cellular telephone comprising:
a) an enclosed volume capable of holding a multitude of articles, wherein said volume is formed by a body having front, back, side, top and bottom walls;
b) one internal wall inside said volume defining two compartments wherein one compartment is capable of holding a cellular telephone and the other compartment is capable of holding other articles;
c) a transparent panel on said compartment capable of holding a cellular phone enabling a cellular phone to be viewable through said transparent panel;
d) two holes in said compartment capable of holding a cellular telephone for the antenna of said cellular phone to extend outside of the walls of said compartment capable of holding a cellular telephone; and
e) one or more light emitting diodes on one or more of the walls of said carrying device connected to at least one receiver wherein said receiver receives a signal when said cellular telephone receives a call and said receiver causes the light emitting diodes to light up upon receiving said signal.

13. That carrying device described in claim 12, wherein said carrying device has a booster cube having front, back, side, top and bottom walls placed at the bottom of said compartment capable of holding a cellular telephone resulting in the display portion of said cellular telephone being viewable through said transparent panel.
